(19) United States
(12) Patent Application Publication
(10) Pub. No.: US 2015/0347692 A1
(43) Pub. Date: Dec. 3, 2015

(54) METHOD AND APPARATUS FOR PROVIDING MOBILE APPS FOR A HEALTHCARE FACILITY

(71) Applicant: AVENTO TECHNOLOGIES, LLC, Huntington Beach, CA (US)

(72) Inventors: Seamaf Bchihalouk, Huntington Beach, CA (US); Adrian Suran, Torrance, CA (US); Chi Lung Chiu, San Gabriel, CA (US)

(21) Appl. No.: 14/292,111

(22) Filed: May 30, 2014

(51) Int. Cl. G06F 19/00

(52) U.S. Cl. CPC G06F 19/325; G06F 19/322

(57) ABSTRACT

The present principles of the embodiments generally relate to providing access of medical electronic records in, e.g., a hospital or a clinic, to various devices including mobile devices such as IPhones, IPad, and Android devices, etc. In particular, the present invention provides a system and a method for enabling different devices, including mobile devices, to interface and work with electronic medical records without having to implement complex medical record protocols such as Health Level 7 (HL7) and/or related protocols in such devices.

### BACKGROUND OF THE INVENTION

1. Field of the Invention

The present principles of the embodiments generally relate to providing access of medical electronic records in, e.g., a hospital or a clinic, to various devices including mobile devices such as IPhones, IPad, and Android devices, etc. In particular, the present invention provides a system and a method for enabling different devices, including mobile devices, to interface and work with electronic medical records without having to implement complex medical record protocols such as Health Level 7 (HL7) compliant protocols in such devices.

2. Background Information

Hospitals are increasingly using mobile solutions for improving patient experience, minimizing mistakes, and reducing paper documentation associated with medical treatments. These mobile solutions require access to electronic medical records (EMR). Electronic medical records contain patient information and related patient events, and are typically communicated using Health Level 7 (HL7) compliant protocols.

Health Level 7 (HL7) compliant and related standards provide a framework for the exchange, integration, sharing, and retrieval of electronic medical records. These standards define how information is packaged and communicated from one party to another, setting the language, structure and data types required for seamless integration between systems. HL7 standards support clinical practice and the management, delivery, and evaluation of health services, and are recognized as the most commonly used in the world.

For example, HL7 ADT (Admit Discharge Transfer) messages carry patient demographic information for HL7 communications as well as important information about trigger events about the patient (such as patient admit, discharge, transfer, registration events, etc.). Some of the most important segments in the ADT message are the PID (Patient Identification) segment, the PV1 (Patient Visit) segment, and occasionally the IN1 (Insurance) segment. ADT messages are common in HL7 processing and are among the most widely used of all message types.

There are 51 different types of ADT messages that are used for various trigger events. Some of the most commonly used ADT messages include:

ADT-A01—patient admit

ADT-A02—patient transfer

ADT-A03—patient discharge

ADT-A04—patient registration

ADT-A05—patient pre-admission

ADT-A08—patient information update

ADT-A11—cancel patient admit

ADT-A12—cancel patient transfer

ADT-A13—cancel patient discharge

ADT messages are important in HL7 communications because they provide relevant data about the patient and why the message is being sent. Trigger events are provided for driving message flow, because they determine when and where messages go, based on the type of event that has occurred.

For instance, an ADT-A01 (patient admit) message might be sent to an Emergency Department system, while an ADT-A04 (patient registration) message might be sent to a hospital information system (HIS). The level of urgency and pace at which the message is transmitted might also be different depending on the trigger event. Additional information regarding HL7 standards can be found on the HL7 standards resource site: http://www.hl7.org/.

Unfortunately, HL7 messages are complicated, long and not user-friendly. An example of a routine ADT-A08 HL7 patient information update message is listed below:
MSH|̂˜\&HOSPITAL123|Facility_NP|̂999999999̂NP|1|||20120220 045504||ADT̂A08|599102|P|2.3.1|||
EVN|A08|20110110045502|||||
PID|0|PFX123456789|MRN12345||JANÊDOE||19911012|F|||123 MAIN ST̂APT 55ÂNEW YORK̂NŶ10004|| (555)555-1212| (555)555-3434||M||a12345|999999999|
PD1|||HEALTHCENTRÊ̂|123456789̂DOCTOR̂1̂̂̂MD̂̂̂̂̂̂̂|
PV1|1|R|||||DOCTOR̂2|DOCTOR̂3|||||||||||||||||||||||||||||||||||20120221|
DG1|1||401.9̂HYPERTENSION, NOS|
DG1|2|I9|786.59|CHEST PAIN|20120106095819-0800|F|
DG1|3|I9|794.31|ABNORMAL EKG|20120106095819-0800|F|
PR1|1||78452|TRESS TEST|20120106095819-0800|
PR1|2||A9500||20120106095819-0800|
PR1|3||93015||20120106095819-0800|
PR1|4||J0152||20120106095819-0800|
PR1|5||J1245||20120106095819-0800|
PR1|6||J0280||20120106095819-0800|
PR1|7||J2785||20120106095819-0800

Before this information is usable, these ADT messages are to be parsed or translated into a format an mobile application can utilize and display in a more user-friendly fashion. Furthermore, acknowledgements are generally required to be sent back following each received message from the EMR database. These acknowledgement messages are also fairly dense, and require parsing of the original message from the EMR in order to generate the acknowledgement message. An example of an acknowledgement or ACK HL7 message is shown below:
MSH|̂˜\&|Facility_NPÎ99999999̂NPI|HOSPITAL 123|2012011004 5504||ACK̂O01|599102|P|2.3.1
MSA|AA|MSGID12349876

Traditionally, each system interfacing with the EMR is standalone. That is each application would have its own interface with the EMR including the implementation of the HL7 protocol, its own parsing and translations of the protocol, its own database, and its own infrastructure, adding to both startup and maintenance costs. In addition, the requirements for the HL7 interface implementations and translations add complexity, time and costs to the development of new mobile apps for hospitals and medical services.

### SUMMARY OF THE INVENTION

The present inventors recognize that the added complexity, time and cost inhibit the ability of developers to create mobile solutions, and impair the ease in which hospitals can implement solutions for different devices such as mobile devices. Therefore, a robust system that allows multiple mobile solutions to be developed and implemented quickly and easily, without the need to implement HL7 compliant protocols for each app and/or additional interfaces or translations is desirable.

An object of the present invention is therefore to provide solutions and improvements to existing systems in accordance with the principles of the present invention and as recognized by the present inventors.

In accordance with an aspect of the present invention, an apparatus is presented, comprising:

a first interface for interfacing with an electronic medical record server using a first protocol, the first protocol is a HL7 (Health Level 7) compliant protocol;

a second interface for interfacing with a first device having a first application using a second protocol, the second protocol is different than the HL7 compliant protocol;

a database for storing HL7 compliant messages to and from the medical record server and for storing application messages to and from the first application; and

a processor for receiving the HL7 compliant messages from the electronic medical record server via the first interface, storing the HL7 compliant messages in the database, and outputting corresponding application messages to the first application via the second interface.

In accordance with another aspect of the present invention, a method is presented, comprising:

communicating with an electronic medical record server in a first protocol, the first protocol is HL7 compliant (Health Level 7) protocol;

communicating with a first device having a first application in a second protocol, the second protocol is different than the HL7 compliant protocol;

receiving HL7 compliant messages from the electronic medical record server;

storing the HL7 compliant messages in the database; and

outputting corresponding application messages to the first application in the first device.

In accordance with another aspect of the present invention, a computer program product stored in a non-transitory computer-readable storage media is presented, comprising computer-executable instructions for:

communicating with an electronic medical record server in a first protocol, the first protocol is HL7 (Health Level 7) compliant protocol;

communicating with a first device having a first application in a second protocol, the second protocol is different than the HL7 compliant protocol;

receiving HL7 compliant messages from the electronic medical record service via a first interface;

storing the HL7 compliant messages in the database; and

outputting corresponding application messages to the first application in the first device via a second interface; and

receiving application messages from the first application and outputting corresponding HL7 compliant messages to the electronic medical record server.

### DETAILED DESCRIPTION OF THE DRAWINGS

The above-mentioned and other features and advantages of this invention, and the manner of attaining them, will become more apparent and the invention will be better understood by reference to the following description of embodiments of the invention taken in conjunction with the accompanying drawings, wherein:

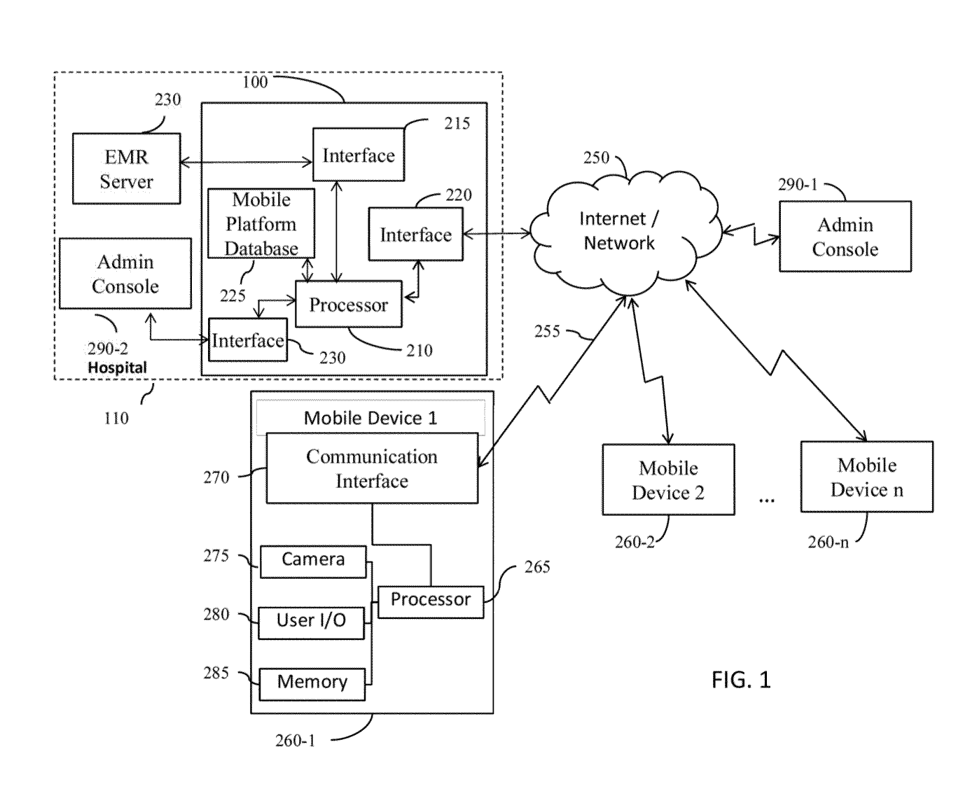

FIG. 1 shows a block diagram of an exemplary system according to the principles of the present invention;

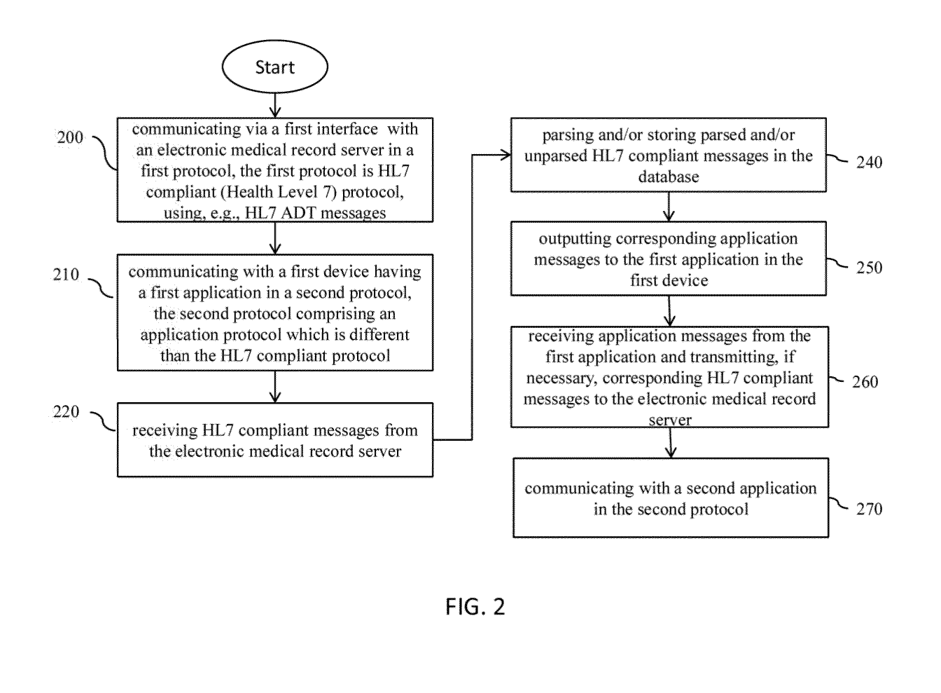

FIG. 2 shows an exemplary process according to the principles of the present invention;

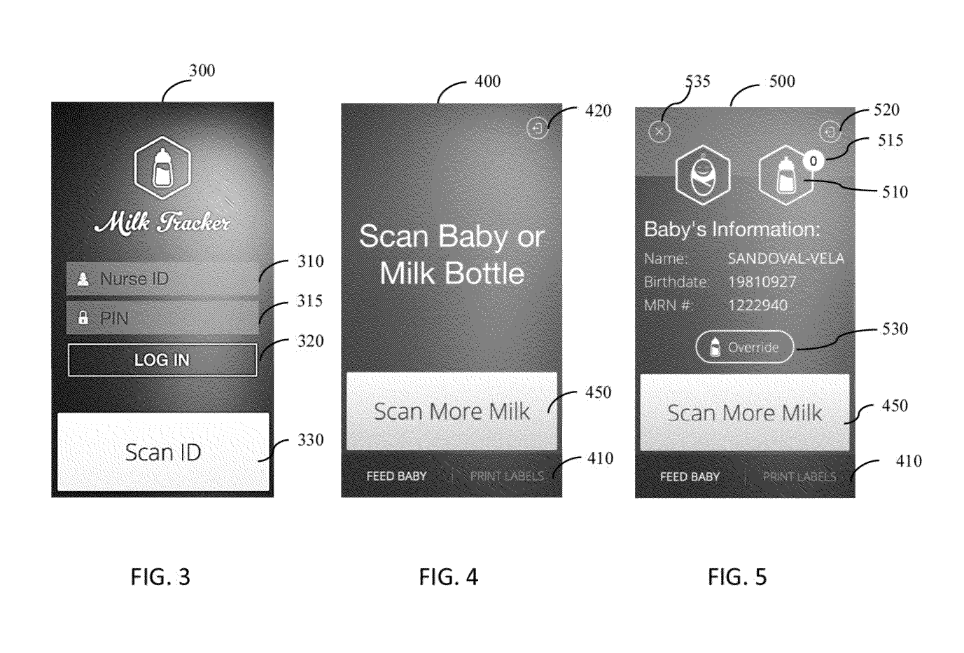

FIG. 3 to FIG. 13 show the various exemplary capabilities and user interface screens of a milk feeding application according to the principles of the present invention;

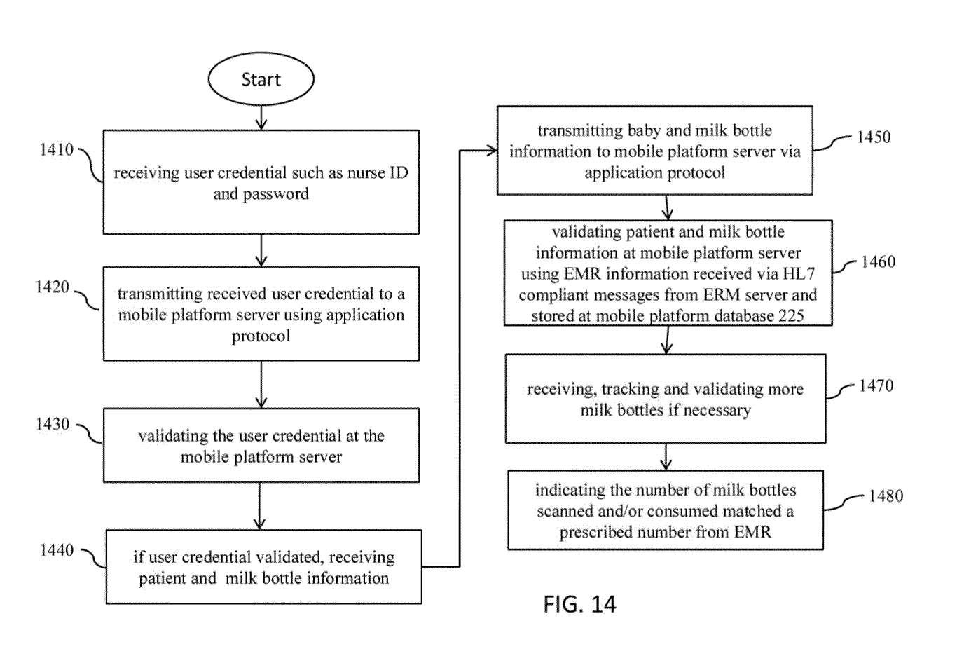

FIG. 14 shows an exemplary process for a milk feeding application according to the principles of the present invention; and

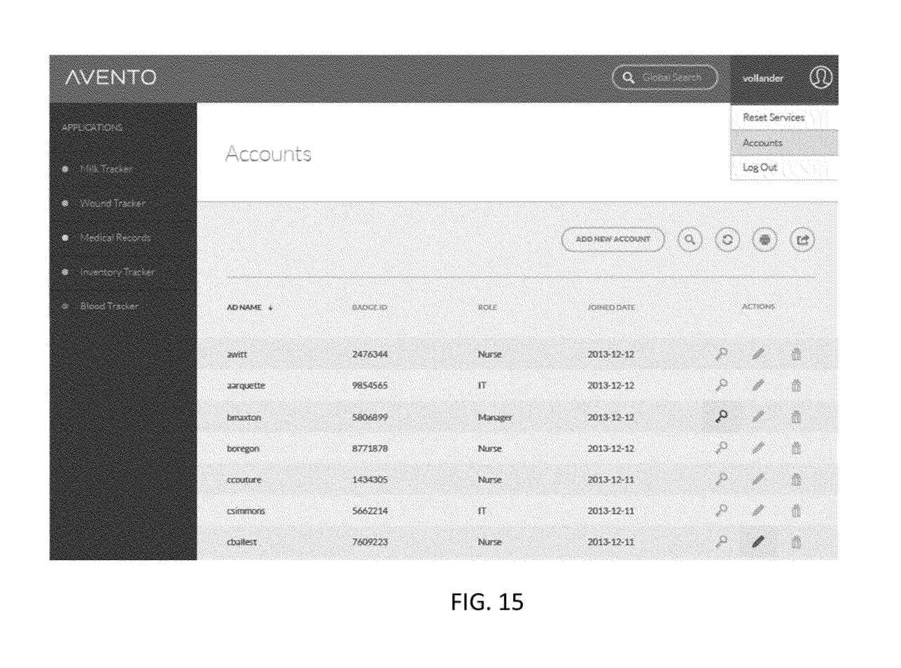

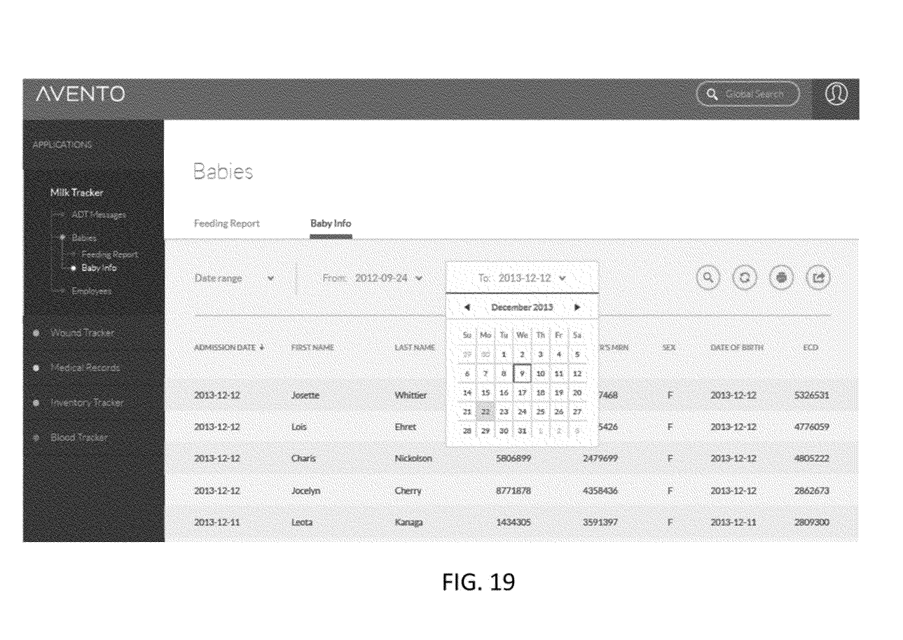

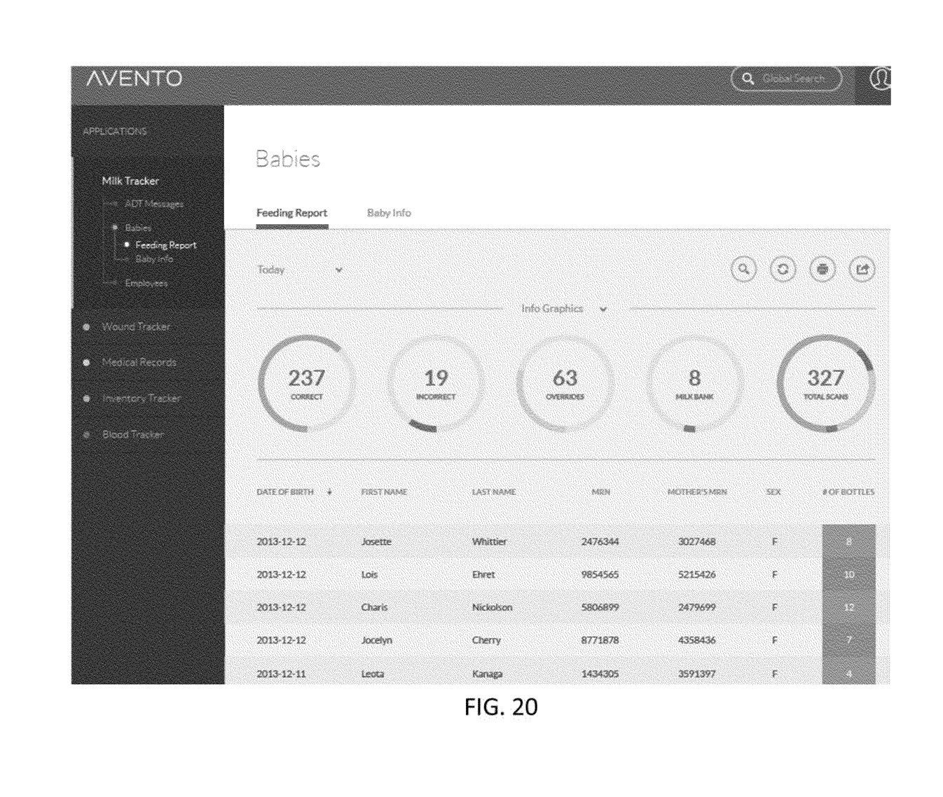

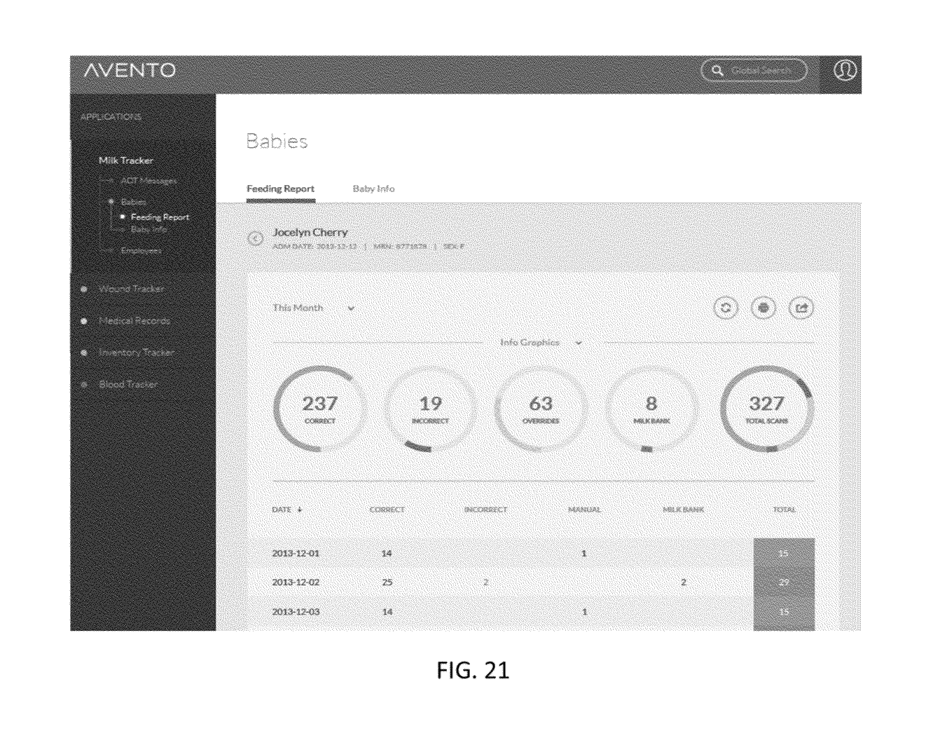

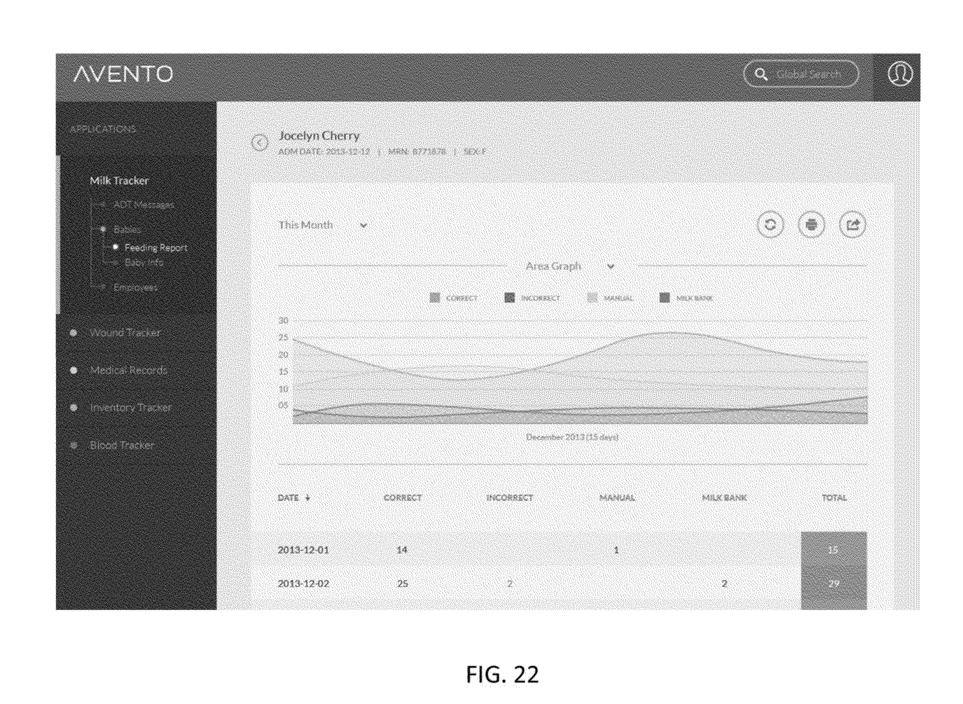

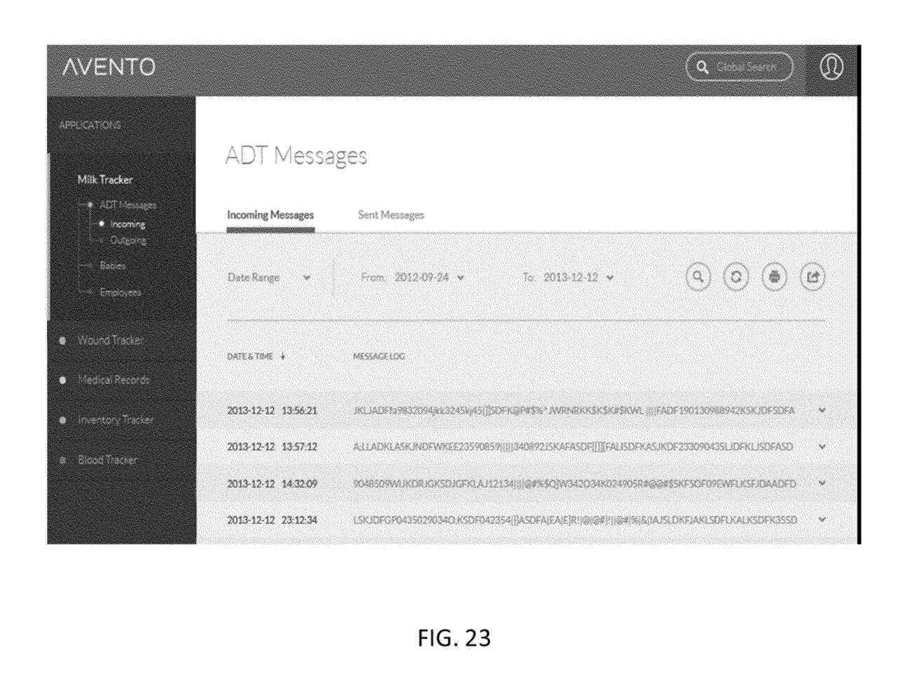

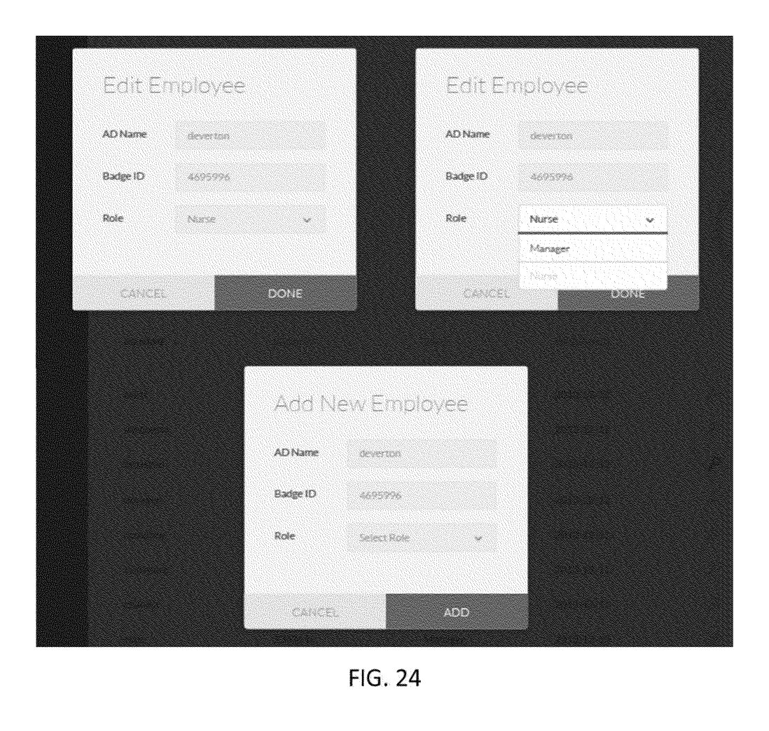

FIG. 15 to FIG. 24 show the various exemplary capabilities and user interface screens of an admin console according to the principles of the present invention.

The examples set out herein illustrate exemplary embodiments of the invention. Such examples are not to be construed as limiting the scope of the invention in any manner.

### DETAILED DESCRIPTION

The present invention provides a mobile platform and is a solution designed to eliminate the need for multiple setups in a hospital environment when rolling out different mobile solutions. One aspect of the present invention is therefore to provide healthcare institutes with a simple, robust, and functional platform to not only setup and install all backend and web services needed for mobile applications, but also to monitor and maintain installed infrastructures and user privileges.

According to the principles of the present invention, a software development interface and platform is provided which allows developers to create apps for hospitals easily without having to know or implement the complicated HL7 compliant protocols and/or messaging. Hence, different app developers can easily develop various medical or clinic related applications for healthcare institutes using the mobile platform and these apps may be made available in an online app store.

According to exemplary aspects, the present invention provides a mobile enterprise application platform that enables enterprise developers to simply and quickly develop applications that connect hospital medical records data to various devices, including mobile devices, by providing a middleware for mapping HL7 compliant protocols and/or messages to application protocols to be used by the various devices. It thus enables hospitals and/or clinics to embrace mobility across the entire organization through the use of a consistent and highly adaptable development platform. One exemplary embodiment of the present invention is therefore to allow parsing of HL7 compliant data and storing them into a mobile platform database so that it can be read by various mobile applications.

Referring now to the drawings, and more particularly to FIG. 1, FIG. 1 represents one exemplary embodiment of a system according the principles of the present invention. As shown in FIG. 1, an apparatus 100 according to the principles of the present invention comprises a processor 210 for processing an exemplary control program shown in FIG. 2 and to be described in detail later. Examples of system 100 may be a server having an Intel processor with processing power of 2.0 GHZ or higher, running Windows 2008 R2, Windows Server 2012, or Linux operating system. One skilled in the art would readily recognize that appropriate storage media, such as one or more hard drives (e.g., 200 GB or higher), RAM memories (e.g., 8 GB or higher), and other server components, are also needed, but are not shown in FIG. 1 to simplify the drawing.

Accordingly, processor 210 communicates with an EMR server 230 through an interface 215. EMR server 230 stores patient electronic medical records and may already be part of a hospital's IT infrastructure 100 as shown in FIG. 1. As noted before, medical establishments rely heavily on EMR infrastructure. EMR infrastructure provides all the necessary details about each patient, medical events relevant to the patient, and/or hospital staff involving in caring for the patient. Interface 215 provides a communication link to EMR server 230 and in particular, one exemplary embodiment of the present invention uses a socket connection on communication port 8000 for such a communication to and from EMR server 230.

As noted before, Health Level 7 (HL7) compliant protocols provide a framework for the exchange, integration, sharing, and retrieval of electronic medical records. In particular, ADT messages are important in HL7 communications because they provide relevant data about the patient and why the message is being sent. Trigger events are also provided for driving message flow, because they determine when and where messages go, based on the type of event that has occurred.

Accordingly, one exemplary embodiment of the present invention is to use HL7 ADT messages that are being sent from and to EMR server via a socket connection on port 8000 of mobile platform server 100. Mobile platform server 100 is built intelligently and knows how to parse the necessary data to make use at a later time. Complete ADT messages including the message header and all characters may be required for the process to continue. Accordingly, mobile platform server 100 accepts HL7 ADT messages on port 8000, parses the data, adds them to a mobile platform database 225, and sends back acknowledgements (e.g., HL7 ACK messages) to EMR 230 on the same socket connection port 8000.

Mobile platform database 225 is the database under the control of processor 210 that mobile platform server 100 sends all parsed HL7 compliant data to for storage and for later consumption by the various healthcare applications residing in various mobile devices. Database 225 is automatically populated with the correct tables, columns, logic, and necessary information so that the needed application messages corresponding to the various applications may be outputted on interface 220. In one exemplary embodiment, interface 220 communicates with applications in various mobile devices via a connection through the internet 250. Similarly, mobile platform server 100 under the control of processor 210 receives application messages from the various mobile apps via interface 220, and may transmit corresponding HL7 compliant messages to the electronic medical record server 230 if necessary, via interface 215. Different user access rights to mobile platform database 225 may be provided as necessary via an administration console (e.g., 290-1 or 290-2) to be described below.

According to aspects of the present invention, an administration console (e.g., 290-1 or 290-2) is provided for healthcare professionals or IT staff to administer and monitor application usages and/or other data that the various mobile applications use. Admin console may also be used to perform maintenance such as, e.g., restarting any necessary services, and allowing or disallowing specific users from using any of the applications and/or the admin console. FIG. 15 to FIG. 24 illustrate the various exemplary capabilities and user interface screens of an admin console according to the principles of the present invention.

Admin console may be provided using a dedicated PC or the like, or using a standard web browser on a PC, laptop, or other mobile devices such as IPhones, IPads or Android cellphones or tablets. In addition, as shown in FIG. 1, an admin console 290-1 may be connected to mobile platform server 100 remotely through the internet or a wide area network 250. In addition, an admin console 290-2 may be connected to mobile platform server 100 locally via a local interface 230 such as, e.g., a USB, an Ethernet, or an optical port.

Mobile platform server 100 provides a middleware and a development platform which allows various apps to be created easily for hospitals and other medical facilities without having to implement the complicated HL7 compliant protocols and/or messaging. Hence, different app developers can easily develop various medical or clinic related applications for healthcare institutes using the mobile platform. The various apps may reside on one of more devices, such as mobile devices 260-1 to 260-n shown in FIG. 1, according to the principles of the present invention.

260-1 of FIG. 1 shows a detailed block diagram of an exemplary mobile device which one or more of the medical applications may reside in according to the principles of the present invention. 260-1 is an example of a typical cellphone or a tablet such as, e.g., an Android phone (e.g., Samsung S3, S4, or S5), an Apple IOS phone (e.g., IPhone 5S or 5C), or an Apple IPad. Such mobile devices would typically include, e.g., a processor 265 for processing various data and controlling various functions and components of the mobile device 260-1, user I/O components 280 which may include a virtual touch keyboard and a display for inputting and/or outputting user data, memory 285 for processing and storing various information as necessary, and a communication interface 270 for connecting and communicating to the mobile platform server 100 via, e.g., the internet 250 using e.g., a Wi-Fi network and/or a cellphone network such as 3G, 4G, LTE, etc.

Accordingly, once a mobile application residing on e.g., mobile device 1 260-1, is ready to receive or send data to the mobile platform server 100, the mobile application will either send a message or request data from mobile platform database 225 via an application protocol which is different and not HL7 compliant. The mobile application will then consume this data and provide the necessary processing needed for the healthcare professional using the mobile application.

FIG. 2 shows an exemplary control program to be run by exemplary server 100 shown in FIG. 1, according to the principles of the present invention. In particular processor 210 executes the steps described in FIG. 2 and controls the relevant components of mobile platform server 100 accordingly. At a high level, control program in FIG. 2 when executed by processor 210, causes server 100 to accept, e.g., HL7 ADT messages on port 8000, parses the data, adds them to mobile platform database 225, and sends back acknowledgements (e.g., HL7 ACK messages) to the EMR on the same socket connection.

According to the principles of the present invention, at step 200 of FIG. 2, processor 210 of mobile platform server 100 communicates via a first interface 215 with an electronic medical record server 230 in a first protocol, the first protocol is HL7 compliant (Health Level 7) protocol, using, e.g., HL7 ADT messages.

At step 210, processor 210 of mobile platform server 100 communicates with a first device, e.g., 260-1, having a first application in a second protocol. The second protocol comprises an application protocol which is different than the HL7 compliant protocol. At step 220, processor 210 of mobile platform server 100 receives HL7 compliant messages, e.g., HL7 ADT messages, from the electronic medical record server 230. At step 240, processor 210 of mobile platform server 100 parses the received HL7 complaint messages such as the HL7 ADT messages and stores the parsed messages in mobile platform database 225. In another embodiment, the complete unparsed HL7 compliant messages may be stored. In yet another embodiment, both parsed and un-parsed HL7 compliant messages are stored for further processing as necessary

At step 250 of FIG. 2, processor 210 of mobile platform server 100 communicates and outputs corresponding application messages to the first application in the first device 260-1 using interface 220, via e.g., the internet 250. At step 260, processor 210 of mobile platform server 100 receives application messages from the first application via interface 220 and if necessary transmits corresponding HL7 compliant messages to the electronic medical record server 230 via interface 215.

As noted before, many different applications residing in many difference devices may communicate with processor 210 of mobile platform server 100 at the same or different times, in a similar way as described before for a first application residing in the first device 260-1. Therefore, as illustrated at step 270, processor 210 of mobile platform server 100 may communicate with a second application in the second protocol which is the application protocol for the second application. The application protocols used to communicate with mobile platform server 100 should be the same in most instances for applications using the same operating system, so that the different applications can be developed easily and consistently.

One exemplary embodiment of a mobile application in a hospital environment to be used in accordance with the teachings of the invention is a milk feeding application. Milk Tracker application is a mobile application which may be implemented in any device with an appropriate operating system such as, e.g., Google Android OS, Apple iOS, MS Windows RT, or MS Windows 8, etc. The application verifies and keeps track of baby milk bottle amount and feeding times and verifications. It is used to ensure that the correct baby is receiving the correct milk or formula, and that the babies are being fed at the correct intervals. FIG. 3 to FIG. 13 show the various exemplary user interface screens of the Milk Tracker app according to the principles of the present invention. In addition, FIG. 15 to FIG. 24 show the various exemplary capabilities and user interface screens of an admin console relating to the milk feeding application.

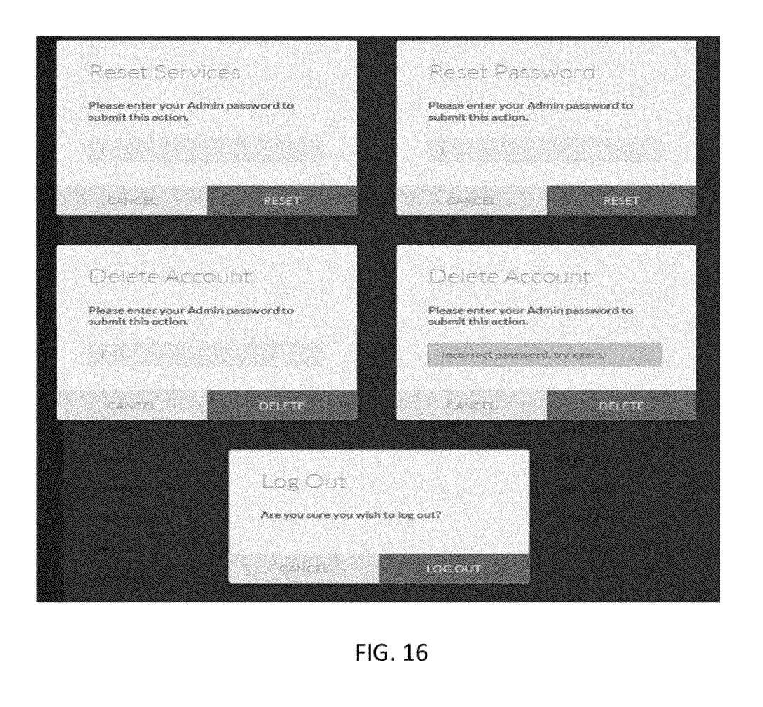

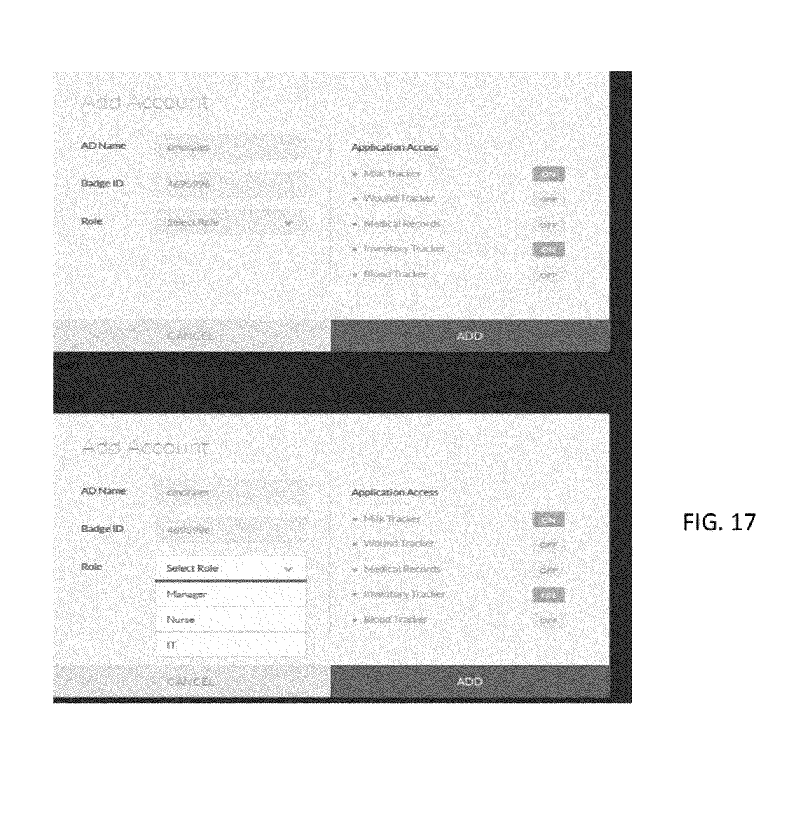

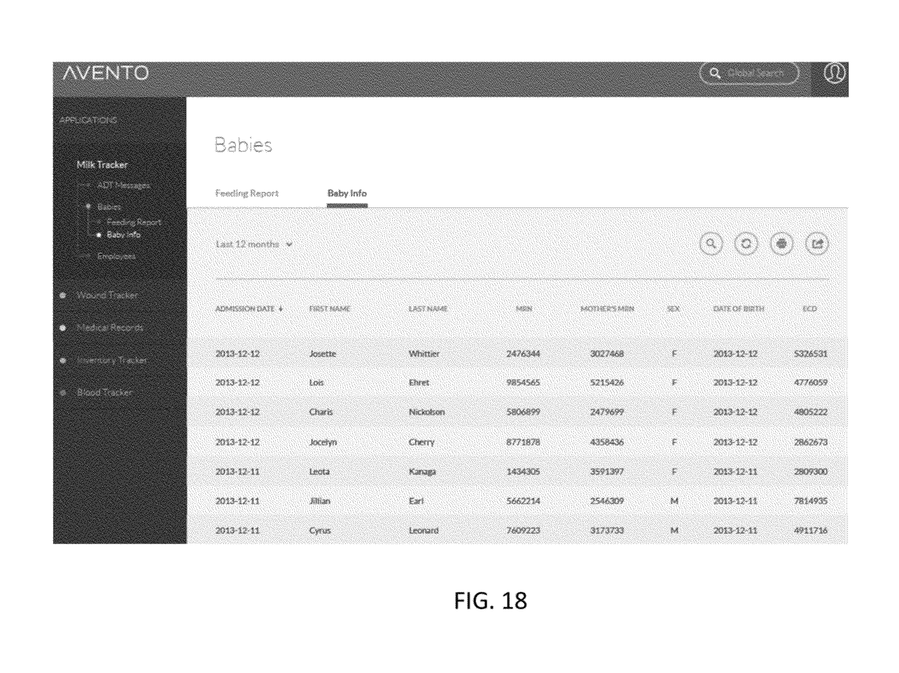

FIG. 3 illustrates a login screen 300 of the baby feeding application for a nurse who will be using the application. An eligible and authorized user list is available through and being monitored by mobile platform server 100, and can be managed from there, via admin console 290-1 or 290-2. FIG. 15 shows an exemplary list of authorized users shown on a screen of an admin console 290-1 or 290-2. FIG. 16 and FIG. 17 show how an authorized user account may be added or deleted.

As shown in FIG. 3, an eligible nurse may enter his or her Nurse ID and PIN in data entry fields 310 and 315 respectively and click on LOG IN icon 320, to gain access to the Milk Tracker application. Alternatively, a nurse may click on Scan ID icon 330 to scan his or her ID in order to enter and verify the information automatically using e.g., different well-known scanning capabilities provided by a mobile device or via external scanning devices connected to the mobile device, including but not limited to technologies such as e.g., RFIDs, NFC tags, QR codes, various other bar codes or magnetic codes technologies, etc.

FIG. 4 shows an exemplary home screen 400 once a user has successfully gain access (i.e., his or her credential has been successfully verified by mobile platform server 100). Screen 400 is also used to verify that the correct milk has been fed to the correct baby. A nurse has the option to scan either the baby wristband or the milk bottle first. As well known in the art, various scanning and inventory tracking technologies may be used to scan the milk bottles and to track the inventory of the milk bottles including and not limited to e.g., RFIDs, NFC tags, QR codes, various other bar codes or magnetic codes technologies, etc. A baby's wrist band may be scanned similarly using the same chosen scanning technology.

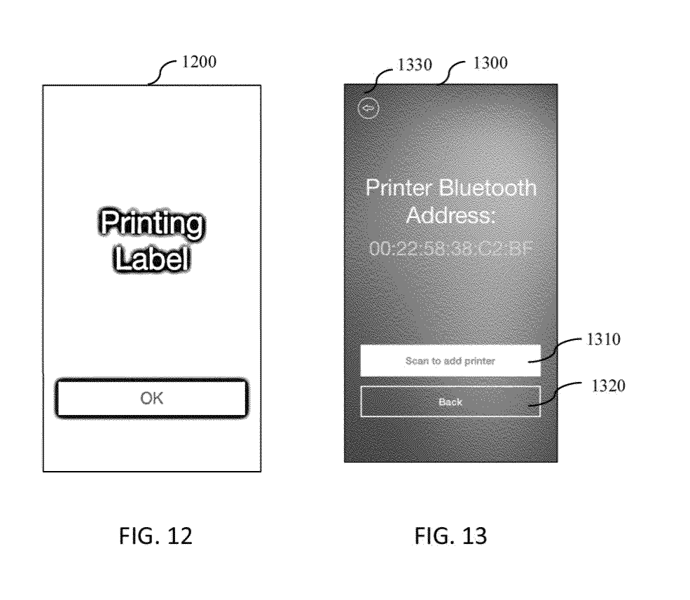

In addition, a nurse is able to go to a label printing screen 1200 (shown in FIG. 12 and to be described later) via PRINT LABELS icon 410 at the bottom right corner of the screen 400 in FIG. 4. The user may also go back to the login screen 300 via a Back icon 420 at the upper right of screen 400. Also, a nurse may press Scan More Milk icon 450 to turn on the scanning capability on the mobile device or an externally connected scanner to begin scanning milk bottles. Alternatively, a physical button or key available on the hardware of the mobile device may be pressed to initiate the scanning.

FIG. 5 shows an exemplary baby information screen 500 which is populated with data once a baby's wristband is scanned as described in connection with FIG. 4. In addition, a milk icon 510 is shown with a number 515 which will increment and correspond to how many milk bottles were counted in the scanning process (e.g., consumed by the baby), if Scan More Milk button 450 is selected in either the previous screen 400 or the present screen 500.

Screen 500 also contains an Override button 530 which will take the user to an override screen 800 shown in FIG. 8 and to be described later. A back button 520 is also available at the upper right of screen 500 which will bring a user back to the previous screen. A clear information button 535 is also available at the upper left which will clear the scanned in data on the screen 500, if a correction or deletion needs to be made.

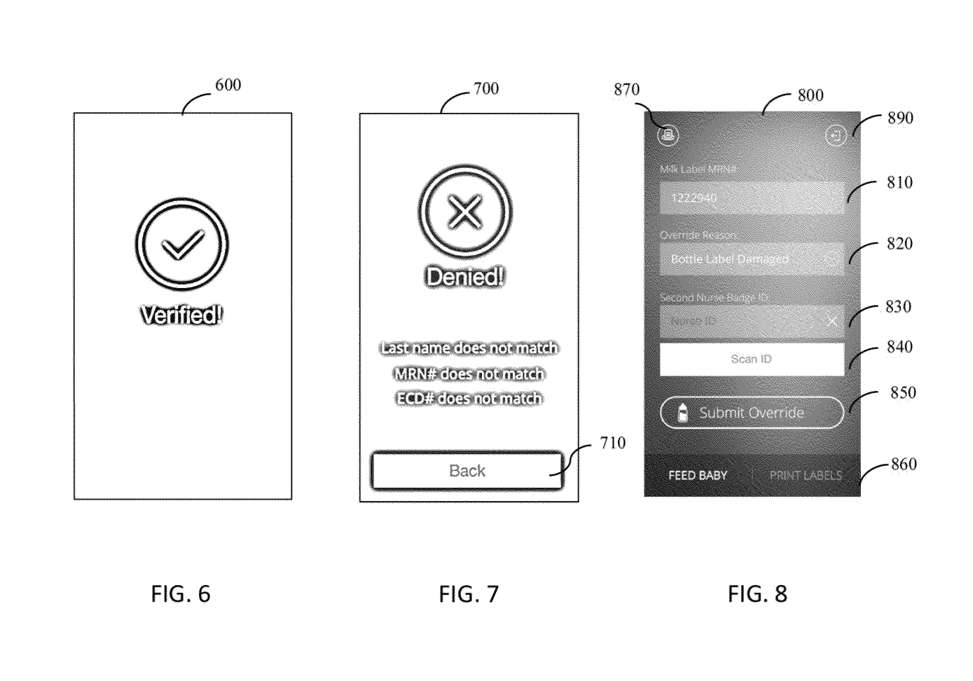

FIG. 6 shows an exemplary screen 600 when medical record information corresponding to the baby scanned or manually entered is successfully verified with the EMR information residing in mobile platform database 225 of mobile platform server 100. Again, this verification is done by processor 210 of mobile platform server 100 in accordance with the exemplary control program shown in FIG. 2 and described in detail previously in connection with FIG. 2, including correlating and translation of necessary application messages needed for Milk Tracker application to and from corresponding HL7 messages needed. The application messages are used, for example, to verify the nurse's credential, baby's identity and to provide user interface information to the user of the Milk Tracker app shown on e.g., screens 500, 900 and 1100.

FIG. 7 shows an exemplary screen 700 when medical information regarding a patient (e.g., a baby) cannot be verified against, e.g., a HL7 ADT message regarding this patient. The reasons for the unsuccessful verification are then presented, e.g., last name, MRN#, and/or ECD# does not match the

EMR record. Upon hitting a back button 710, the application returns to a previous or a home screen 400 of FIG. 4.

FIG. 8 shows an example of an override screen 800 as mentioned previously. Screen 800 may be presented when a nurse hits Override button 530 that is present upon receiving the baby information as shown and described in connection with screen 500 of FIG. 5. One exemplary use of override screen 800 is to provide nursing staff with ability to feed a baby in an event that a scanning barcode is damaged or is unable to be read by a scanner of the Milk Tracker application.

As shown in FIG. 8, screen 800 gives the ability to the staff to enter and note information manually regarding the milk feeding. For example, a nurse may override a Milk Label MRN (Medical Record Number which is associated to the baby) as shown in 810 of FIG. 8. The nurse may also enter an override reason in a note section 820 to provide a reason e.g., as to why this override is necessary. In one exemplary embodiment, this note section 820 may be implemented either as free text entry, or as a dropdown menu of predetermined reasons. In an exemplary embodiment, for security and verification purposes, a second nurse may need to verify that the information provided is correct for the override by providing his or her ID in field 830. The Nurse ID text field may be cleared by selecting the X in the box 830. Once the data is entered, the nurse may then click Submit Override 850 which will automatically populate the data within the mobile platform database 225 and then allow the nurse to feed the baby.

Also in FIG. 8, print icon 870 at the top left gives the nurse the ability to go a select printer screen 1300 shown in FIG. 13 and to be described later. A PRINT LABELS icon 860 at the lower right of screen 800 will allow the user to go to the Print Labels screen 1100 shown in FIG. 11 to be described later. Again, Back icon 890 at the upper right will bring the user to back to a previous page.

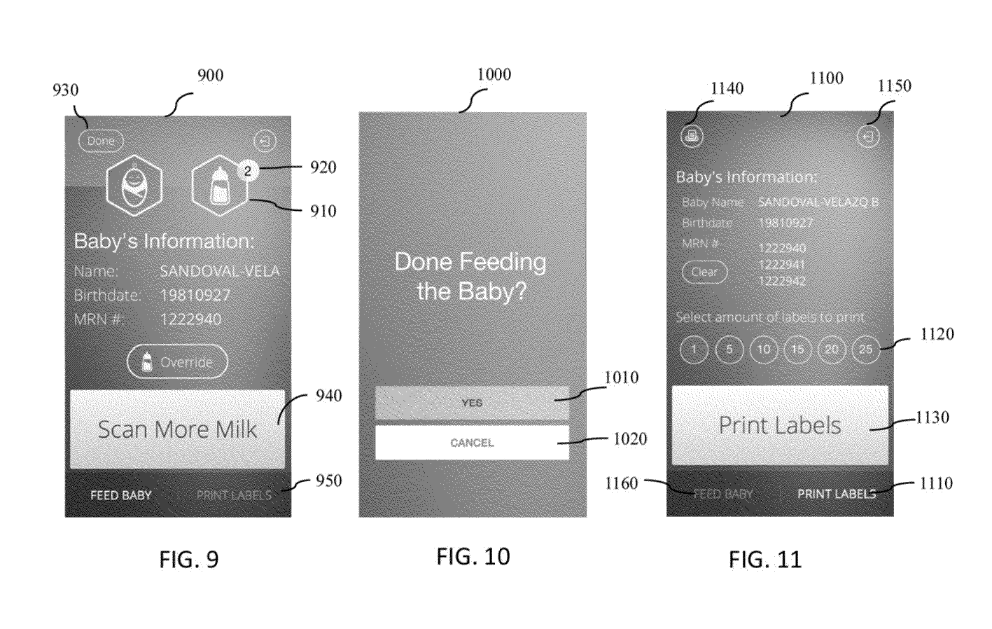

FIG. 9 shows an example of a home screen when a nurse has successfully fed a baby named SANDOVAL-VELA with the correct number of milk bottles as provided by the EMR. In this example, the baby has been fed 2 bottles of milk as indicated by the number icon 920 showing the number 2. When this number matches the number of bottles prescribed by his or her pediatrician, icon 910 is highlighted and/or turns into a different color (e.g., red to green) to indicate that the prescribed number of bottles has been reached. Once the nurse is finished the feeding process and the application, the nurse would then select the Done button 930 to exist home screen 900.

Upon selecting Done on the Home Screen 900 as shown in FIG. 9, an exemplary screen 1000 shown in FIG. 10 may be presented to verify that the nurse is finished feeding. If the Nurse selects YES 1010, the application resets to the default home screen 400 shown in FIG. 4. If the nurse hits CANCEL 1020, the nurse is returned to a previous screen 900 shown in FIG. 9 with previous values still populated on the screen 900.

FIG. 11 shows an exemplary default screen upon selecting PRINT LABELS icon 410 shown in previous described screens. Once a baby is scanned, the baby's information is presented on screen 1100. The nurse may clear the information if it is incorrect. Alternatively, the nurse may select to print the information shown on screen 1100 to a label and also be able to select how many labels he or she would like to print. Once a number is selected using a row of selection icons 1120, the nurse may select PRINT LABELS 1110 to print the number of labels to a printer. When labels are being printed, a screen 1200 shown in FIG. 12 may be further presented to the user for further verification. After the selected number of labels has been printed, the application will return to screen 1100 shown in FIG. 11.

In addition, screen 1100 contains a Back icon 1150 at the upper right which will return the application to a previous page, a Select Printer button 1140 at the upper left which will bring the user to a select printer screen 1300 shown in FIG. 13 to be described latter, and the FEED BABY button 1160 which will bring the user to the home screen 400 in FIG. 4.

FIG. 13 shows an example of a printer selection screen 1300. Screen 1300 is designated for the selection of a printer available in the hospital facility. In one exemplary embodiment, a printer will have a barcode located somewhere on the printer that contains the Printer Bluetooth Address for the mobile application to communicate with the printer. Once the Scan to add printer icon 1310 is selected and the printer barcode is scanned, screen 1300 will be populated with the correct Mac Address of the printer automatically and labels may be printed via Bluetooth. Back selection icons 1320 and 1330 are available for the user to select to go back to a previous screen.

FIG. 14 shows an exemplary control program for the milk feeding app to be run by an exemplary mobile device 260-1 shown in FIG. 1 according to the principles of the present invention. In particular, processor 265 of a mobile device 260-1 executes the steps described in FIG. 14 to implement the milk feeding and tracking healthcare app and to controls relevant components of the exemplary mobile device 260-1 accordingly.

At step 1410 of FIG. 14, Milk Tracker application receives user credential such as nurse ID and password as shown on screen 300 of FIG. 3. At step 1420, Milk Tracker application transmits the received user credential to a mobile platform server 100 using an appropriate protocol for use with the Milk Tracker application. This protocol is not HL7 compliant. At step 1430, the received user credential is validated at the mobile platform server 100. At step 1440, if user credential is validated, a home screen 400 shown in FIG. 4 is presented to the user in order to receive patient and milk bottle information, e.g., via different scanning technologies as described before.

At step 1450 of FIG. 14, the scanned or entered baby and milk bottle information from the Milk Tracker app are transmitted to mobile platform server 100 via the application protocol. At step 1460, the scanned or entered patient and milk bottle information are validated at mobile platform server using EMR information received via HL7 compliant messages from ERM server 230. At step 1470, if more bottles are needed, additional bottle information are received from the app, and further validated and tracked against EMR information received via HL7 compliant messages from ERM server 230 and stored at mobile platform database 225. At step 1480, the Milk Tracker app will indicate to a user if the number of milk bottles scanned and/or consumed matches a prescribed number, e.g., by highlighting or turning milk icon 910 shown on screen 900 of FIG. 9 to a different color (e.g., green).

While several embodiments have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present embodiments. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings herein is/are used. Those skilled in the art will recognize, or be able to ascertain using no more than routine experimentation, many equivalents to the specific embodiments described herein. It is, therefore, to be understood that the foregoing embodiments are presented by way of example only and that, within the scope of the appended claims and equivalents thereof, the embodiments disclosed may be practiced otherwise than as specifically described and claimed. The present embodiments are directed to each individual feature, system, article, material and/or method described herein. In addition, any combination of two or more such features, systems, articles, materials and/or methods, if such features, systems, articles, materials and/or methods are not mutually inconsistent, is included within the scope of the present embodiments. For example, although interfaces 215, 220, 230 are shown as separate interfaces in FIG. 1, one skilled in the art can readily recognize and appreciate the these interfaces may be implement in one integrated circuit or the like, or that 1 physical interface may perform the functions of all three interfaces, depending on the capabilities of a specific hardware, software or firm implementation.

What is claimed is:

1. An apparatus comprising:
a first interface for interfacing with an electronic medical record server using a first protocol, the first protocol is a HL7 (Health Level 7) compliant protocol;
a second interface for interfacing with a first device having a first application using a second protocol, the second protocol is different than the HL7 compliant protocol;
a database for storing HL7 compliant messages to and from the medical record server and for storing application messages to and from the first application; and
a processor for receiving the HL7 compliant messages from the electronic medical record server via the first interface, storing the HL7 compliant messages in the database, and outputting corresponding application messages to the first application via the second interface.

2. The apparatus of claim 1 wherein the apparatus further comprising:
the processor communicates with a second application using the second protocol.

3. The apparatus of claim 1 wherein the HL7 compliant messages comprising HL7 ADT (Admit Discharge Transfer) messages.

4. The apparatus of claim 1 further comprising:
The processor receives application messages from the first device and transmits corresponding HL7 compliant messages to the electronic medical record server.

5. The apparatus of claim 4 wherein the received application messages are stored in the database before the corresponding HL7 compliant messages are transmitted to the electronic medical record service.

6. The apparatus of claim 1 wherein the first application comprising a baby feeding application.

7. The apparatus of claim 1 further comprising:
a user interface for providing administration and monitoring of one of more applications.

8. The apparatus of claim 1, wherein the first device is a mobile device.

9. The apparatus of claim 1, wherein the stored HL7 compliant messages comprise parsed HL7 compliant messages.

10. A method comprising:
communicating with an electronic medical record server in a first protocol, the first protocol is HL7 compliant (Health Level 7) protocol;
communicating with a first device having a first application in a second protocol, the second protocol is different than the HL7 compliant protocol;
receiving HL7 compliant messages from the electronic medical record server;
storing the HL7 compliant messages in the database; and
outputting corresponding application messages to the first application in the first device.

11. The method of claim 10 further comprising:
communicating with a second application in the second protocol.

12. The method of claim 10 wherein the HL7 compliant messages may comprise HL7 ADT (Admit Discharge Transfer) messages.

13. The method of claim 10 further comprising:
receiving application messages from the first application and transmitting corresponding HL7 compliant messages to the electronic medical record server.

14. The method of claim 13 wherein the received application messages are stored in the database.

15. The method of claim 10 wherein the first application comprising a baby feeding application.

16. The method of claim 10 further comprising:
providing a user interface for administration and monitoring of one of more applications.

17. The method of claim 10, wherein the stored HL7 compliant messages are parsed HL7 compliant messages.

18. The method of claim 10, further comprising:
entering information about a patient using the first device;
transmitting the information to the processor using the second protocol; and
transmitting the corresponding information to the medical record server using the HL7 compliant protocol.

19. The method of claim 10 wherein one or more applications may be provided without the one or more applications having implemented HL7 compliant protocol.

20. A computer program product stored in a non-transitory computer-readable storage media comprising computer-executable instructions for:
communicating with an electronic medical record server in a first protocol, the first protocol is HL7 (Health Level 7) compliant protocol;
communicating with a first device having a first application in a second protocol, the second protocol is different than the HL7 compliant protocol;
receiving HL7 compliant messages from the electronic medical record service via a first interface;
storing the HL7 compliant messages in the database; and
outputting corresponding application messages to the first application in the first device via a second interface; and
receiving application messages from the first application and outputting corresponding HL7 compliant messages to the electronic medical record server.
